(19) United States
(12) Patent Application Publication
(10) Pub. No.: US 2023/0398533 A1
(43) Pub. Date: Dec. 14, 2023

(54) METHODS FOR REPLACING A SPENT CATALYST OF A REACTOR TRAIN OF AN OPERATING HYDROPROCESSING SYSTEM

(71) Applicant: SHELL USA INC., HOUSTON, TX (US)

(72) Inventors: Coen Bernhard HODES, Amsterdam (NL); Edmundo Steven VAN DOESBURG, Amsterdam (NL)

(21) Appl. No.: 18/248,920

(22) PCT Filed: Nov. 11, 2021
(86) PCT No.: PCT/EP2021/081395

§ 371 Date: Apr. 13, 2023

(30) Foreign Application Priority Data
Nov. 13, 2020 (EP) 20207631.1

(51) Int. Cl. B01J 38/10; B01J 23/90; B01J 19/18

(52) U.S. Cl. CPC B01J 38/10; B01J 23/90; B01J 19/18; B01J 2219/00337; C10G 47/00

(57) ABSTRACT

The present disclosure relates to a method for replacing a catalyst of a reactor train of an operating hydroprocessing system comprising a plurality of reactor trains comprising a catalyst and each configured to receive a feed fluid and combine a portion of the feed fluid with a hydrogen stream over the catalyst to generate a hydrotreated fluid, the method comprising activating a valving system of the operating hydroprocessing system to disrupt operation of a select reactor train comprising a spent catalyst to form a disrupted reactor train while maintaining operation of at least one other reactor train; activating the gas processing system to form a decontaminated catalyst, removing the decontaminated catalyst from the disrupted reactor train to form a catalyst free reactor train; loading the catalyst free reactor train with a fresh catalyst to produce a charged reactor train; and restoring operation of the catalyst charged reactor train.

### FIELD OF THE DISCLOSURE

The present disclosure relates, in some embodiments, to methods for replacing a catalyst of a reactor train of an operating hydroprocessing system for treating a feed fluid (e.g., crude feed fluid, bio feed fluid, combinations of crude and bio feed fluids).

### BACKGROUND OF THE DISCLOSURE

Humans derive energy from the combustion of hydrocarbon fuel products developed and refined from both renewable (e.g., bio feedstock) and nonrenewable (e.g., fossil fuels) sources. Hydroprocessing systems are used to refine raw feed fluids (e.g., fossil fuels, bio feed stocks, combinations) into hydrocarbon fuels suitable for combustion. However, as a hydroprocessing system converts a raw feed fluid into hydrocarbon fuels, it slowly consumes the catalyst required to facilitate the chemical conversion. Spent catalyst no longer produces viable hydrocarbon products and must be replaced.

Additionally, the requirements on hydroprocessing systems are increasingly stringent to meet specific hydrocarbon product needs such as contaminant removal, product novelty and use, and sustainability. These additional requirements have resulted in an overall increase in catalyst deactivation rates. One method of addressing the rapidly reducing catalyst deactivation rates is to refresh the spent catalyst more frequently. However, while refreshing the catalyst increases hydroprocessing unit performance, existing methods for replacing spent catalyst do so by shutting down the entire system so that the reactor trains can be sanitized and then charged with fresh catalyst. The more frequent interruption impacts the manufacturing operation, resulting in direct lost production time and higher operating costs, as well as resulting in decreased manufacturing flexibility of the complex of multiple unit operations, decreased ability of processing at the manufacturing complexes capacity, and lost flexibility of processing the full variety of crude oils. Also, system shutdowns can last for weeks, leading to significant hydrocarbon production loss, possibly also of upstream and downstream systems, leading to major losses in overall profit. Methods and systems are needed that can replace a spent catalyst on an operating hydroprocessing system.

### SUMMARY

Accordingly, there is a need for improved methods and systems for replacing a spent catalyst of a reactor train of an operating hydroprocessing system. [The present disclosure relates to a method for replacing a catalyst of a reactor train of an operating hydroprocessing system, the operating hydroprocessing system having a plurality of reactor trains with each reactor train including a catalyst and each configured to receive a feed fluid and combine a portion of a feed fluid with a catalyst to generate a hydrotreated fluid. A method may include (a) activating a valving system of an operating hydroprocessing system to disrupt operation of a select reactor train comprising a spent catalyst to form a disrupted reactor train while maintaining operation of at least one other reactor train of a plurality of reactor trains. Each of a plurality of reactor trains may be fluidly connected to a valving system such that when activated a valving system can independently disrupt operation of each of a plurality of reactor trains. Each of a plurality of reactor trains may be further connected to a gas processing system configured to remove a contaminant from a spent catalyst. In some embodiments, a method includes (b) activating a gas processing system to remove a contaminant from a spent catalyst to form a decontaminated catalyst. A method may include (c) removing a decontaminated catalyst from a disrupted reactor train to form a catalyst free reactor train. A method may include (d) loading a catalyst free reactor train with a fresh catalyst to produce a charged reactor train. A method may include (e) restoring operation of a charged reactor train.

A capacity of an operating hydroprocessing system may be maintained at at least 25% throughout steps (a) through (d) of a method. A method may include activating a valving system of a operating hydroprocessing system to disrupt operation of two or more select reactor trains to form two or more disrupted select reactor trains while maintaining operation of at least one other reactor train of a plurality of reactor trains. In some embodiments, loading a catalyst free reactor train with a fresh catalyst further may include loading a catalyst free reactor train with a fresh catalyst comprising one or more of an oxidic catalyst, a palladium catalyst, a platinum catalyst, a nickel catalyst, a cobalt catalyst, a nickel catalyst, a tungsten catalyst and a molybdenum catalyst.

A method may include activating a hydrocarbon liquid pump to remove a hydrocarbon mixture from a disrupted reactor train. A method may include activating a feed system to stop flow of a feed gas comprising a hydrocarbon mixture to a select reactor train before disrupting operation of a select reactor train. A method may include activating a feed system to start flow of a feed gas to a catalyst charged reactor train after restoring operation to a catalyst charged reactor train. A method may include activating a pressure release valve to reduce a pressure of a disrupted reactor train to about 1 atm. A method may include activating a gas pump to insert a gas containing one or more of hydrogen, nitrogen, argon, and combinations thereof, to a catalyst charged reactor train, reaching a pressure ranging from about 10 atm to about 150 atm. Removing a decontaminated catalyst may include one or more of manually removing a catalyst and mechanically removing a catalyst.

A system for replacing a catalyst of a reactor train of an operating hydroprocessing system may include (a) a hydroprocessing system containing a plurality of reactor trains each reactor train containing a catalyst and each configured to receive a feed fluid and combine a portion of a feed fluid with a hydrogen stream over a catalyst to generate a hydrotreated fluid. A system may include (b) a valving system comprising a valve and is fluidly connected to each of a plurality of reactor trains through a reactor connector. A valving system may be configured to disrupt and restore operation of a select reactor train comprising a spent catalyst to form a disrupted reactor train. A system may include (c) a gas processing system connected to each of a plurality of reactor trains through a gas connector A gas processing system may be configured to remove a contaminant from a spent catalyst. A system may include a feed system connected to each of a plurality of reactor trains through a feed connector. A feed system may be configured to stop flow of a feed gas comprising a hydrocarbon mixture to a select reactor train before disrupting operation of a select reactor train. A feed system may be configured to start flow of a feed gas to catalyst charged reactor train after a valving system has restored operation to a catalyst charged reactor train. Each of a plurality of reactor trains may include one or more hydroprocessing reactors. A fresh catalyst may include one or more of an oxidic catalyst, a palladium catalyst, a platinum catalyst, a nickel catalyst, a cobalt catalyst, a nickel catalyst, a tungsten catalyst and a molybdenum catalyst.

A system may include a feed system containing a feed tank and a feed pump that are both connected to each of a plurality of reactor trains through a feed line, a feed pump configured to transfer a hydrocarbon feed from a feed tank to each of a plurality of reactor trains through a feed line. A system may include a separation zone containing one or more condensers and one or more separation vessels and attached to each of a plurality of reactor trains through a separation connector. A separation zone may be configured to receive a hydroprocessed product from each of a plurality of reactor trains through a separation connector and to separate a hydroprocessed product into a hydrocarbon fraction comprising one or more of a heavy fraction having an atmospheric boiling point of above about 540° C., an intermediate fraction having an atmospheric boiling point of between about 370° C. and about 540° C., and a light fraction having an atmospheric boiling point of less than about 370° C. A system may include a compression zone connected to a separation zone through a first compression connector and connected to each of a plurality of reactor trains through a second compression connector. A compression zone may be configured to receive a hydrogen rich vapour fraction from a separation zone through a first compression connector. A compression zone may be configured to transfer a hydrogen rich vapour fraction as a recycle from a compression zone to one or more of a plurality of reactor trains through a second compression connector. A gas processing system may include a gas pump, a cooler and a separator tank. A separator tank may include one or more of hydrogen, nitrogen, and argon. A gas pump may be configured to fill each of a plurality of reactor trains with a gas at a pressure ranging from about 10 atm to about 150 atm. A gas processing system may include a tank configured to receive a contaminant from a spent catalyst and where a pump is configured to facilitate transfer of a contaminant from a spent catalyst to a tank.

### BRIEF DESCRIPTION OF THE DRAWINGS

Some embodiments of the disclosure may be understood by referring, in part, to the present disclosure and the accompanying drawings, wherein:

FIG. 1 is a diagram of a hydroprocessing system configured to replace a spent catalyst of a reactor train of the operating hydroprocessing system, according to specific example embodiments of the disclosure;

FIG. 2A is a diagram of a hydroprocessing system with reactor train 1 at high pressure and reactor train 2 and normal operation, according to specific example embodiments of the disclosure; and

FIG. 2B is a diagram of a hydroprocessing system with reactor train 2 at normal operation and reactor train 1 at low pressure, according to specific example embodiments of the disclosure.

### DETAILED DESCRIPTION

The present disclosure relates, in some embodiments, to methods and systems for replacing a spent catalyst of a reactor train of an operating hydroprocessing system. A spent catalyst is one that has limited (e.g., unprofitable levels of hydrocarbon fuels production) or no catalytic capacity in comparison to a fresh catalyst and replacement is desirable. Being able to replace a spent catalyst without completely shutting down a hydrocarbon processing system would allow for increased productivity, and possibly continuation of upstream and downstream systems, and a reduction in profit losses. The present disclosure relates to methods and systems for replacing a spent catalyst with a fresh catalyst while maintaining a hydrocarbon production capacity (e.g., of greater than about 25% of it's fully operational status but more likely greater than 50%). The present disclosure is also applicable to existing hydroprocessing systems which may be retrofitted to allow for catalyst replacement without a full system shutdown.

### Systems for Replacing a Spent Catalyst of a Reactor Train

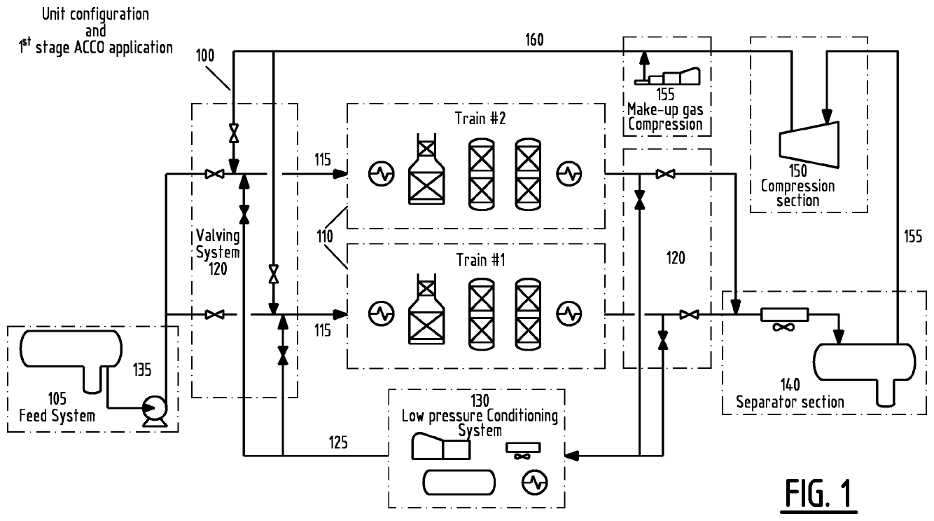

According to some embodiments, as shown in FIG. 1, a disclosed system 100 for replacing a catalyst (e.g., a spent catalyst) may include a plurality of reactor trains 110. A disclosed system includes two or more reactor trains 110. Each reactor train 110 may contain one or more hydroprocessing reactors located inside the reactor trains 110. Each reactor train 110 may be configured to receive a feed fluid and combine a portion of the feed fluid with a hydrogen stream over a catalyst to generate a hydrotreated fluid. A disclosed system may include a valving system 120, a feed system 105, a gas processing system 130, a separator zone 140, and a compression zone 150, that are each fluidly connected to each reactor train 110 through a series of connectors. For example, each reactor train 110 may be fluidly connected to a valving system 120 through one or more reactor connectors. A valving system 120 contains one or more valves and conduits that may control a flow of fluid to and from each reactor train 110. A valving system may be configured to use one or more valves and conduits to switch, start or stop flow of fluids from any of the other systems to and from each reactor train 110. A valve can be any type of known valve, including one or more of a gate valve, a globe valve, a ball valve, and others. A valving system 120 may include gauges including one or more of a flow meter gauge, a pressure gauge, a temperature gauge, and others. A valving system 120 may be manually operated or may be automated such a by a computer program.

In some embodiments, as shown in FIG. 1, a system 100 may include a feed system 105 connected to each of a plurality of reactor trains through a feed connector 135. A feed system 105 may include a feed filter, a feed tank and a feed pump that is configured to transport a feed from a feed tank to each reactor train through a feed connector 135. The feed system may be a single feed system feeding to all reactor trains or may be multiple feed systems, each feeding to only one or a limited number of reactor trains. A valving system 120 may start or stop flow of a feed from a feed system 105 to each reactor trains as the valving system 120 intercepts flow of the feed from the valving system 120 to each reactor train 110.

As shown in FIG. 1, a system may include a gas processing system 130 connected to each of a plurality of reactor trains 110 through a feed connector 125. A gas processing system 130 may include a condenser system, a circulation compressor or blower, a pump and a tank. A gas processing system 130 may be configured to remove a contaminant from a spent catalyst contained within a reactor train 110. A contaminant removed from a spent catalyst may be transferred from a reactor train 110 to a tank of a gas processing system 130 through a feed connector 125. A pump contained within a gas processing system 130 may aid in using fluid pressure to transport a contaminant from a spent catalyst to a tank. In some embodiments, a gas pump may circulate a gas to cool down a disrupted train to a lower temperature and a lower pressure to allow for spent catalyst removal and/or access.

According to some embodiments, as shown in FIG. 1, a system 100 may include a separation zone 140 connected to each reactor train 110 through a separator connector 145. A separation zone 140 may include scrubbing facilities, one or more condensers and one or more separation vessels that are each contained within the separation zone 140. A hydrocarbon fraction may include one or more of a heavy fraction having an atmospheric boiling point of above about 540° C., an intermediate fraction having an atmospheric boiling point of between about 370° C. and about 540° C., and a light fraction having an atmospheric boiling point of less than about 370° C. A separation zone 140 may receive a hydroprocessed product in one or more separation vessels from where the hydroprocessed product will be fed to the fractionation section

In some embodiments, a system may include a compression zone 150 connected to a separation zone 140 through a compression connector 155 and to a reactor train 110 through a second compression connector 160. A compression zone 150 may be configured to receive a hydrogen rich vapour fraction from a separation zone 140 through a compression connector. A hydrogen rich vapour fraction received from a separation zone 140 may be recycled back to various system 100 parts (e.g., reactor train) through a second compression connector. The recycle gas compressor compresses the vapours from separator section 140. While the fresh gas compressor 155 makes up for the chemical consumption and physical losses of hydrogen, the recycle gas provides additional mass that helps to maintain a high hydrogen partial pressure across the reactor.

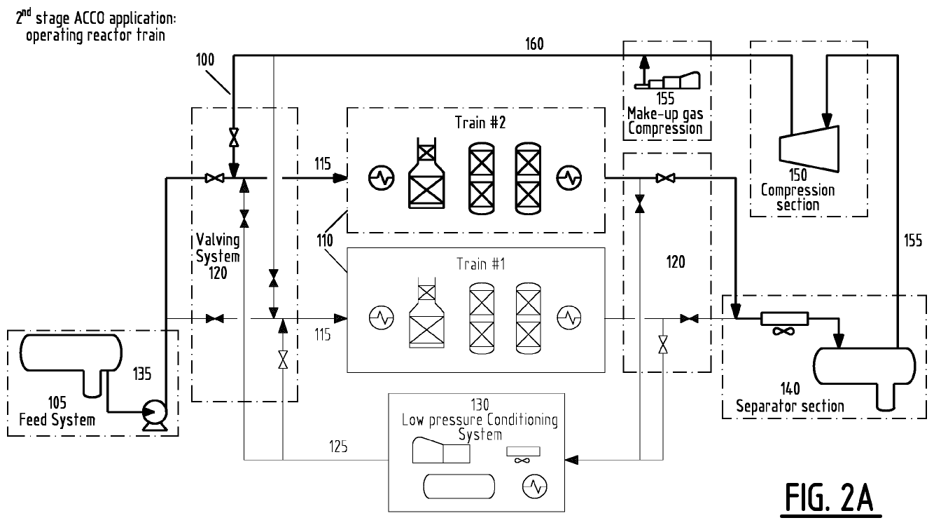

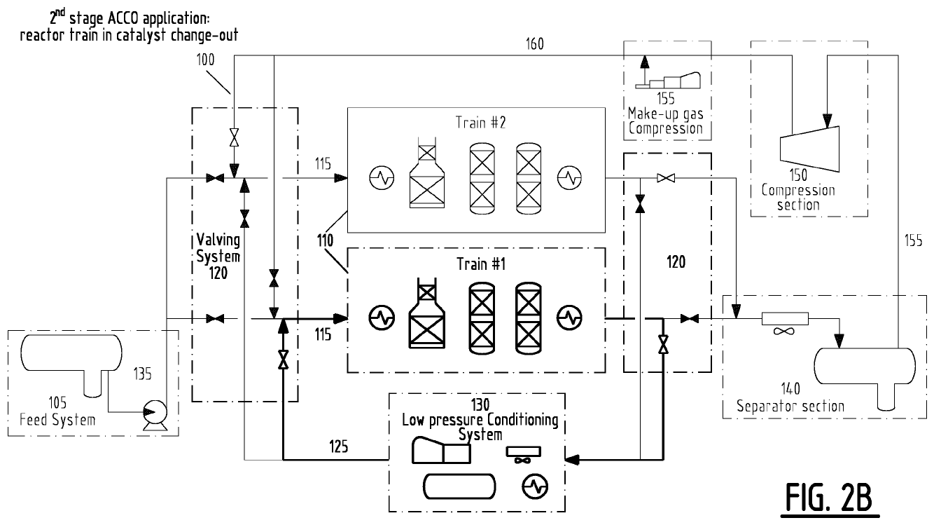

FIGS. 2A and 2B are diagrams of various configurations of a hydroprocessing system according to some embodiments of the present disclosure. FIG. 2A is a diagram of a hydroprocessing system with reactor train 1 being flushed and isolated from the high pressure reactor circuit while reactor train 2 continues normal operation, according to specific example embodiments of the disclosure. FIG. 2A and FIG. 2B shows a first train isolation stage. FIG. 2B is a diagram of a hydroprocessing system with reactor train 2 at a normal operation and reactor train 1 at a reduced pressure where the catalyst is being further stripped form residual hydrocarbons. After catalyst decontamination, the catalyst can be removed, and fresh catalyst will be loaded in the reactors. Train 1 is subsequently pressurized, and the catalyst activated. After completion of fresh catalyst activation, train 1 can be reconnected in the reactor circuit, via the valve system 120, conform FIG. 1. The same disconnecting, catalyst replacement and reconnecting steps can then be applied to train 2 in the second train isolation stage, after which both reactor trains have fresh catalyst and a next catalyst cycle commences.

Catalyst replacement from two reactor trains may be conducted in the same manner as when a whole unit would be shut down, with the primary difference that one reactor train continues operation while catalyst replacement happens on the other disconnected reactor train.

### Methods for Replacing a Spent Catalyst of a Reactor Train

The present disclosure relates to a method for replacing a catalyst of a reactor train 110 of an operating hydroprocessing system 100 while maintaining greater than about 25% of a full capacity of the hydroprocessing system 100. A disclosed method may include disrupting operation of one or more reactor trains 110 while one or more reactor trains 110 continue to run so that a hydroprocessing system 100 maintains greater than about 25% of its full capacity. For example, a method may maintain greater than about 50% of a full capacity by disrupting operation of one reactor train 110 while continuing operation of one reactor train 110. A method may maintain a greater than about 66% of a full capacity by disrupting operation of one reactor train 110 while continuing operation of two reactor trains 110. A method may include disrupting operation of one to ten reactor trains 110 while continuing operation of one to ten reactor trains 110. In some embodiments, a method may include replacing a spent catalyst with a fresh catalyst while a hydroprocessing system 100 operates at at least about 25% capacity throughout each of the steps. A method may include replacing a spent catalyst with a fresh catalyst while a hydroprocessing system 100 operates at at least about 10% capacity, or at least about 15% capacity, or at least about 20% capacity, or at least about 25% capacity, or at least about 30% capacity, or at least about 35% capacity, or at least about 40% capacity, or at least about 45% capacity, or at least about 50% capacity, or at least about 55% capacity, or at least about 60% capacity, or at least about 65% capacity, or at least about 70% capacity, or at least about 75% capacity, or at least about 80% capacity, or at least about 85% capacity, or at least about 90% capacity, or at least about % capacity, or at least about 99% capacity, throughout each of the steps, where about includes plus or minus 2.5% capacity. A method may include replacing a spent catalyst with a fresh catalyst while a hydroprocessing system 100 operates ranging from about 10% to about 20%, or about 20% to about 30%, or about 30% to about 40%, or about 40% to about 50%, or about 50% to about 60%, or about 60% to about 70%, or about 70% to about 80%, or about 80% to about 90%, or about 90% to about 99%, throughout each of the steps, where about includes plus or minus 2.5% capacity. In some embodiments, a method may include replacing a spent catalyst with a fresh catalyst while operating at between about 50% to about 75% while having two reactor trains. In some embodiments, a method may include replacing a spent catalyst with a fresh catalyst while operating at between about 65% to 90% capacity while having three reactor trains.

A method may be performed on a hydroprocessing system 100 having a plurality of reactor trains 110 where each of the reactor trains includes a catalyst. A method may include receiving a feed fluid with each reactor train 110 and then combining a portion of the feed fluid with a hydrogen stream over a catalyst to generate a hydroprocessed fluid. A hydroprocessed fluid may be a fluid that has been one or more of hydrotreated, hydrogenated, hydroisomerized, and/or hydrocracked. A disclosed method may include a step of activating a valve system of an operating hydroprocessing system 100 to disrupt operation of a select reactor train having a spent catalyst while maintaining operation of at least one other reactor train of a plurality of reactor trains. For example, if a method is operating on a system 100 having two reactor trains, one reactor train may be have its operation disrupted while the other maintains operation. Disrupting operation of a select reactor train forms a disrupted reactor train that is no longer producing a hydroprocessed fluid while the still operating reactor train is still producing the hydroprocessed fluid. A valving system 120 is fluidly connected each of the plurality of reactor trains so that a method may activate the valving system 120 to disrupt or begin operation of any of the reactor trains at a given time.

After a reactor train 110 is disrupted, a pressure contained within a reactor of the reactor train 110 may be reduced. Gaseous and/or liquid contaminants may be removed from a spent catalyst contained within a disrupted reactor train 110 to form a decontaminated catalyst. To do this, a method may include a step of activating a gas processing system 130 to depressurize a disrupted reactor train. A step of activating a gas processing system 130 may include activating a pressure release valve to reduce a pressure of a disrupted reactor train to about 1 atm. A pressure may be reduced to below about 20 atm, or below about 15 atm, or below about 10 atm, or below about 5 atm, or below about 1 atm, where about includes plus or minus 2.5 atm. A pressure may be reduced to about 20 atm to about 15 atm, or about 15 atm to about 10 atm, or about 10 atm to about 5 atm, or about 5 atm to about 1 atm, where about includes plus or minus 2.5 atm. A method may also include a step of activating a hydrocarbon liquid pump to remove a hydrocarbon mixture from the disrupted reactor train. In some embodiments, a method may include a step of activating a gas processing system 130 to remove a contaminant (e.g., a hydrocarbon, a hydrogen sulfide) from a spent catalyst. A method may include activating a gas processing system 130 to not only remove a contaminant from a spent catalyst, but to transfer it from the disrupted reactor train to a contaminant collection tank through a contaminant connection. In some embodiments, a method may include a step of removing a decontaminated catalyst from a disrupted reactor train. Removing a decontaminated catalyst may include removal of free flowing catalyst, mechanically and/or manually removing the spent catalyst, using a vacuum based apparatus to remove the spent catalyst, and using a flushing fluid (e.g. water, solvent) to remove the spent catalyst. Removal of a spent catalyst may include dumping the spent catalyst, vacuum unloading the spent catalyst, and hydro jetting the spent catalyst from a disrupted reactor train. Removing a decontaminated catalyst from a disrupted reactor train forms a catalyst free reactor train that is ready to be charged with fresh catalyst.

In some embodiments, a method may include a step of loading a catalyst free reactor train with a fresh catalyst to produce a charged reactor train. A fresh catalyst includes a catalyst containing one or more of an oxidic catalyst, a palladium catalyst, a platinum catalyst, a nickel catalyst, a cobalt catalyst, a tungsten catalyst, and a molybdenum catalyst. A method may include a step of restoring operation of a catalyst charged reactor train. Restoring operation of a catalyst charged reactor train may include one or more of: activating a feed system 105 to transfer a feed from a feed tank to a catalyst charged reactor train, activating a gas processing system 130 so that a gas pump inserts a gas (e.g., hydrogen, nitrogen, argon) into the catalyst charged reactor train, and activating a valving system 120 seal off the catalyst charged reactor train so that it may continue hydrocarbon production. A method may activate a gas processing system 130 so that a gas pump inserts a gas into a reactor train 110 so that it reaches a pressure ranging from about 10 atm to about 150 atm. A gas pressure may reach a pressure of about 10 atm, or about 25 atm, or about 50 atm, or about atm, or about 100 atm, or about 125 atm, or about 150 atm, where about includes plus or minus 12.5 atm. A gas pressure may reach a pressure of from about 10 atm to about 25 atm, or about 25 atm to about 50 atm, or about 50 atm to about 75 atm, or about 75 atm to about 100 atm, or about 100 atm to about 125 atm, or about 125 atm to about 150 atm, where about includes plus or minus 12.5 atm.

In some embodiments, a method may include a step of activating a feed system 105 to start or stop flow of a feed gas to a select reactor train 110. For example, a method may include activating a feed system 105 to stop flow of a feed gas to a select reactor train before a step of disrupting operation of the select reactor train. A method may include a step of activating a feed system 105 to begin flow of a feed gas to a select reactor train (e.g., catalyst charged reactor train) after a step of restoring operation to a reactor train (e.g., catalyst charged reactor train). In some embodiments, a method may include a step of beginning or ending flow of a feed gas to a select reactor train before or after any method step.

### EXAMPLES

The following examples illustrate some specific example embodiments of the present disclosure. These examples represent specific approaches found to function well in the practice of the application, and thus can be considered to constitute examples of modes for its practice. However, those of skill in the art should, in light of the present disclosure, appreciate that many changes can be made in the specific embodiments that are disclosed without departing from the spirit and scope of the application.

### Example 1

A heavy oil hydroprocessing unit was revamped in design to allow for consecutive catalyst unloading and loading of each of the two reactor trains. The specified unit consists of two reactor trains operating at some 150 bar and 400° C., requiring particular catalyst washing and decontamination procedures.

It is understood that the listed components for each unit are for illustration purposes only, and this is not intended to limit the scope of the application. A specific combination of these or other components or units can be configured in such a composition or method for the intended use based on the teachings in the application.

Persons skilled in the art may make various changes in the shape, size, number, separation characteristic, and/or arrangement of parts without departing from the scope of the instant disclosure. Each disclosed component, system, and process step may be performed in association with any other disclosed component, system, or process step and in any order according to some embodiments. Where the verb “may” appears, it is intended to convey an optional and/or permissive condition, but its use is not intended to suggest any lack of operability unless otherwise indicated. Persons skilled in the art may make various changes in processes of preparing and using a composition, device, and/or system of the disclosure. Where desired, some embodiments of the disclosure may be practiced to the exclusion of other embodiments.

Also, where ranges have been provided, the disclosed endpoints may be treated as exact and/or approximations as desired or demanded by the particular embodiment. Where the endpoints are approximate, the degree of flexibility may vary in proportion to the order of magnitude of the range. For example, on one hand, a range endpoint of about 50 in the context of a range of about 5 to about 50 may include 50.5, but not 52.5 or 55 and, on the other hand, a range endpoint of about 50 in the context of a range of about 0.5 to about 50 may include 55, but not 60 or 75. In addition, it may be desirable, in some embodiments, to mix and match range endpoints. Also, in some embodiments, each figure disclosed (e.g., in one or more of the examples, tables, and/or drawings) may form the basis of a range (e.g., depicted value+/−about 10%, depicted value+/−about 50%, depicted value+/−about 100%) and/or a range endpoint. With respect to the former, a value of 50 depicted in an example, table, and/or drawing may form the basis of a range of, for example, about 45 to about 55, about 25 to about 100, and/or about 0 to about 100.

These equivalents and alternatives along with obvious changes and modifications are intended to be included within the scope of the present disclosure. Accordingly, the foregoing disclosure is intended to be illustrative, but not limiting, of the scope of the disclosure as illustrated by the appended claims.

The title, abstract, background, and headings are provided in compliance with regulations and/or for the convenience of the reader. They include no admissions as to the scope and content of prior art and no limitations applicable to all disclosed embodiments.

What is claimed is:

1. A method for replacing a catalyst of a reactor train of an operating hydroprocessing system, the operating hydroprocessing system comprising a plurality of reactor trains, each reactor train comprising at least one reactor comprising a catalyst and each reactor train configured to receive a feed fluid and combine a portion of the feed fluid with the catalyst to generate a hydrotreated fluid, the method comprising:
(a) activating a valving system of the operating hydroprocessing system to disrupt operation of a select reactor train comprising a spent catalyst to form a disrupted reactor train while maintaining operation of at least one other reactor train of the plurality of reactor trains,
wherein each of the plurality of reactor trains is fluidly connected to the valving system such that when activated the valving system can independently disrupt operation of each of the plurality of reactor trains,
wherein each of the plurality of reactor trains is further connected to a gas processing system configured to remove a contaminant from the spent catalyst;
(b) activating the gas processing system to remove the contaminant from the spent catalyst to form a decontaminated catalyst,
(c) removing the decontaminated catalyst from the disrupted reactor train to form a catalyst free reactor train;
(d) loading the catalyst free reactor train with a fresh catalyst to produce a charged reactor train; and
(e) restoring operation of the charged reactor train.

2. The method according to claim 1, wherein one or more of:
a capacity of the operating hydroprocessing system is maintained at at least 50% throughout steps (a) through (d) of the method;
loading the catalyst free reactor train with the fresh catalyst further comprises loading the catalyst free reactor train with the fresh catalyst comprising one or more of an oxidic catalyst, a palladium catalyst, a platinum catalyst, a nickel catalyst, a cobalt catalyst, a nickel catalyst, a tungsten catalyst and a molybdenum catalyst; and
the removing the decontaminated catalyst comprises one or more of manually removing the catalyst and mechanically removing the catalyst.

3. The method according to claim 1, further comprising one or more of:
activating a hydrocarbon liquid pump to remove a hydrocarbon mixture from the disrupted reactor train;
activating a feed system to stop flow of a feed gas comprising a hydrocarbon mixture to the select reactor train before disrupting operation of the select reactor train;
activating the feed system to start flow of the feed gas to the catalyst charged reactor train after restoring operation to the catalyst charged reactor train;
activating a pressure release valve to reduce a pressure of the disrupted reactor train to about 1 atm; and
activating a gas pump to insert a gas comprising one or more of hydrogen, nitrogen, argon, and combinations thereof, to the catalyst charged reactor train, reaching a pressure ranging from about 10 atm to about 150 atm.

4. A system for replacing a catalyst of a reactor train of an operating hydroprocessing system, the system comprising:
(a) the hydroprocessing system comprising a plurality of reactor trains each reactor train comprising a catalyst and each configured to receive a feed fluid and combine a portion of the feed fluid with a hydrogen stream over the catalyst to generate a hydrotreated fluid;
(b) a valving system comprising a valve and is fluidly connected to each of the plurality of reactor trains through a reactor connector, wherein the valving system is configured to disrupt and restore operation of a select reactor train comprising a spent catalyst to form a disrupted reactor train; and
(c) a gas processing system connected to each of the plurality of reactor trains through a gas connector, wherein the gas processing system is configured to remove a contaminant from the spent catalyst.

5. The system according to claim 4, further comprising one or more of:
a feed system connected to each of the plurality of reactor trains through a feed connector, the feed system configured: (a) to stop flow of a feed gas comprising a hydrocarbon mixture to the select reactor train before disrupting operation of the select reactor train, and (b) to start flow of the feed gas to catalyst charged reactor train after the valving system has restored operation to the catalyst charged reactor train; and
a feed system comprising a feed tank and a feed pump that are both connected to each of the plurality of reactor trains through a feed line, the feed pump configured to transfer a hydrocarbon feed from the feed tank to each of the plurality of reactor trains through the feed line.

6. The system according to claim 4, wherein one or more of:
each of the plurality of reactor trains comprises one or more hydroprocessing reactors, and
the fresh catalyst comprises one or more of an oxidic catalyst, a palladium catalyst, a platinum catalyst, a nickel catalyst, a cobalt catalyst, a nickel catalyst, a tungsten catalyst and a molybdenum catalyst.

7. The system according to claim 4, further comprising a separation zone comprising a one or more condensers and one or more separation vessels and attached to each of the plurality of reactor trains through a separation connector, wherein the separation zone is configured to receive a hydroprocessed product from each of the plurality of reactor trains through the separation connector and to separate the hydroprocessed product into a hydrocarbon fraction comprising one or more of a heavy fraction having an atmospheric boiling point of above about 540° C., an intermediate fraction having an atmospheric boiling point of between about 370° C. and about 540° C., and a light fraction having an atmospheric boiling point of less than about 370° C.

8. The system according to claim 7, further comprising a compression zone connected to a separation zone through a first compression connector and connected to each of the plurality of reactor trains through a second compression connector, wherein the compression zone is configured to one or more of:
receive a hydrogen rich vapour fraction from the separation zone through the first compression connector, and
transfer the hydrogen rich vapour fraction as a recycle from the compression zone to one or more of the plurality of reactor trains through the second compression connector.

9. The system according to claim 4, wherein the gas processing system further comprises: a gas pump, a cooler, and a separator tank,
wherein the gas pump is configured to fill each of the plurality of reactor trains with a gas at a pressure ranging from about 10 atm to about 150 atm, and
wherein the gas comprises one or more of hydrogen, nitrogen, and argon.

10. The system according to claim 9, wherein the gas processing system further comprises a tank configured to receive the contaminant from the spent catalyst and where the pump is configured to facilitate transfer of the contaminant from the spent catalyst to the tank.
